(19) United States
(12) Patent Application Publication
(10) Pub. No.: US 2019/0353755 A1
(43) Pub. Date: Nov. 21, 2019

(54) LIDAR SENSOR FOR DETECTING AN OBJECT

(71) Applicant: Robert Bosch GmbH, Stuttgart (DE)

(72) Inventors: Hans-Jochen Schwarz, Stuttgart (DE); Klaus Stoppel, Mundelsheim (DE); Reiner Schnitzer, Reutlingen (DE); Thomas Fersch, Muenchen (DE); Thorsten Balslink, Kirchentellinsfurt (DE); Jan Sparbert, Rutesheim (DE)

(21) Appl. No.: 16/484,172

(22) PCT Filed: Feb. 7, 2018
(86) PCT No.: PCT/EP2018/053026

§ 371 Date: Aug. 7, 2019

(30) Foreign Application Priority Data
Feb. 20, 2017 (DE) 10 2017 202 635.9

(51) Int. Cl. G01S 7/481; G01S 17/08

(52) U.S. Cl. CPC G01S 7/4812; G01S 17/08

(57) ABSTRACT

A lidar sensor for detecting an object in the surrounding area, and a method for activating the lidar sensor, the lidar sensor including: a light source for emitting electromagnetic radiation; a deflection mirror for deflecting the emitted electromagnetic radiation, as deflected emitted electromagnetic radiation, through at least one angle into the surrounding area; and an optical receiver for receiving electromagnetic radiation that has been reflected from the object. The optical receiver has an aperture region disposed on a main beam axis of the light source.

### FIELD OF THE INVENTION

The present invention relates to a lidar sensor and to a method for activating a lidar sensor.

### BACKGROUND INFORMATION

The existing art concerns a variety of sensor devices that allow objects to be detected within a scanning space in the surrounding area of, for example, a vehicle. These include light detection and ranging (lidar) sensors, with which the surrounding area of the vehicle is scanned. The electromagnetic radiation emitted from a lidar sensor is reflected or scattered back from objects in the surrounding area, and received by an optical receiver of the lidar sensor. The position and distance of objects in the surrounding area can be determined on the basis of this received radiation.

Patent document DE 10 2008 055159 A1 discusses an apparatus for sensing the geometry of the surrounding area of the apparatus in a detection array by laser scanning, using a laser beam deflected by an oscillating micromechanical mirror. The detection array is definable in a vertical and a horizontal direction by adapting the oscillation amplitude and/or the oscillation frequency of the micromechanical mirror.

Lidar sensors that have a smaller overall volume or shorter overall height than previous solutions would be advantageous for mounting lidar sensors in a space-saving manner in or on specific regions of a vehicle. A demand furthermore exists for mechanically robust lidar sensors, in particular for use in vehicles.

### SUMMARY OF THE INVENTION

The present invention proceeds from a lidar sensor for detecting an object in the surrounding area, having at least one light source for emitting electromagnetic radiation; having at least one deflection mirror for deflecting the emitted electromagnetic radiation, as deflected emitted electromagnetic radiation, through at least one angle into the surrounding area; and having at least one optical receiver for receiving electromagnetic radiation that has been reflected from the object.

According to the present invention, the optical receiver has an aperture region, the aperture region being disposed on a main beam axis of the light source.

The deflection mirror can be moved oscillatingly along an axis. The deflection mirror in this instance is one-dimensional. Alternatively, the deflection mirror can be moved oscillatingly along two axes. The deflection mirror in this instance is two-dimensional.

Plausibilization of a measured distance of an object detected in the surrounding area can be carried out based on the position and power level of the electromagnetic radiation received on the optical receiver. This capability results from the fact that the deflection mirror produces a shift in the received electromagnetic radiation in accordance with the time of flight of the electromagnetic radiation.

The advantage of the invention is that a lidar sensor having a small overall volume, in particular a low overall height, can be implemented. Because the aperture region is disposed on a main beam axis of the light source, the beam path of the emitted electromagnetic radiation and the beam path of the received electromagnetic radiation can proceed coaxially. Optical losses in the beam paths of the emitted and received electromagnetic radiation can be very largely avoided. The received electromagnetic radiation in particular can be received in a very largely loss-free manner by the optical receiver. The optical receiver can be sufficiently large and sufficiently sensitive.

In an advantageous embodiment of the invention, provision is made that the optical receiver has at least one detector element that at least in part surrounds the aperture region. The optical receiver can be embodied, for example, as a single annular detector element. The optical receiver can be embodied, for example, as a single semi-annular detector element. The optical receiver can furthermore be embodied as a single polygonal detector element. Such detector elements are easy to implement in terms of manufacture.

In a further advantageous embodiment of the invention, provision is made that the optical receiver has at least two detector elements that are disposed on at least part of the periphery of the optical receiver. The advantage of this embodiment is that different configurations and geometries for the optical receiver can be implemented depending on the demands on the lidar sensor.

In an exemplary embodiment of the invention, provision is made that the aperture region is embodied as a passage. The passage can be a hole. Alternatively, the passage can be a material that very largely allows the emitted electromagnetic radiation to pass.

In a particular embodiment of the invention, provision is made that the light source is disposed on that side of the optical receiver which faces away from the surrounding area. The advantage of this embodiment is that a very compact coaxial lidar sensor can be implemented.

In a further embodiment of the invention, provision is made that the aperture region is embodied as a mirror. The advantage of this embodiment is that further geometries of the beam path can be implemented depending on the demands on the lidar sensor.

In a particular embodiment of the invention, provision is made that the light source is disposed on that side of the optical receiver which faces toward the surrounding area. The advantage of this embodiment is that a very compact coaxial lidar sensor can be implemented.

In a further embodiment of the invention, provision is made that the deflection mirror is embodied as a micromechanical deflection mirror. Both the emitted electromagnetic radiation that impinges upon the deflection mirror, and the received electromagnetic radiation that impinges upon the deflection mirror, can have a small beam diameter. As a result, a physically small deflection mirror having a correspondingly high scanning frequency can be used. A lidar sensor that is sufficiently mechanically robust can be implemented.

In an advantageous embodiment of the invention, provision is made that the lidar sensor furthermore has an array of micro-optical elements. The deflection mirror and the array are disposed in such a way that each of the at least one angles is associated with exactly one micro-optical element. Several angles of different magnitudes can be associated with each element.

In an exemplary embodiment of the invention, the lidar sensor furthermore has a light-collimating element that is disposed at a distance from the array of micro-optical elements. Each of the micro-optical elements, when impinged upon by the deflected emitted electromagnetic radiation, expands that deflected emitted electromagnetic radiation into a divergent beam. The light-collimating element reshapes the divergent beam into a scanning beam. The advantage of this embodiment is that eye safety can be ensured even when the total output of the emitted electromagnetic radiation is elevated. The beam diameter of the scanning beam can be larger than the pupil diameter of the human eye. Sensitivity with regard to scattering particles can be minimized.

The emitted electromagnetic radiation deflected at the deflection mirror scans not the surrounding area directly, but instead the array of micro-optical elements. The direction in which the scanning beam is radiated depends on the location of the respectively impinged-upon micro-optical element relative to the optical axis of the light-collimating element. The aperture angle of the lidar sensor can therefore be appreciably wider than the maximum angle through which the electromagnetic radiation is deflected at the deflection mirror. Scanning with a wide aperture angle is thereby made possible.

In a further embodiment of the invention, provision is made that the micro-optical elements are microlenses or reflective or light-diffracting elements.

The collimating element can be an optical lens in whose focal plane the array of micro-optical elements is located. The divergent beam is thereby reshaped into a scanning beam in which the rays are almost parallel. Alternatively, a concave mirror would also be conceivable instead of a lens.

In a further embodiment of the invention, provision is made that the light-collimating element simultaneously constitutes an objective of the optical receiver. As a result, the received electromagnetic radiation can be coaxial with the emitted electromagnetic radiation. No parallel errors therefore need to be taken into account when evaluating the received electromagnetic radiation.

In a further embodiment of the invention, provision is made that a mirror unit, which diverts the deflected emitted electromagnetic radiation onto the array of micro-optical elements, is disposed on the optical axis of the light-collimating element. Received electromagnetic radiation can also be diverted onto the deflection mirror by way of the mirror unit. The advantage of this embodiment is that the beam path of the lidar sensor can be adapted.

In a particular embodiment of the invention, provision is made that the mirror unit is embodied convexly. The advantage of this embodiment is that aberrations can be compensated for.

A method for activating a lidar sensor for detecting an object in the surrounding area is also claimed according to the present invention. The method has the following steps: activating a light source to emit electromagnetic radiation; activating a deflection mirror to deflect the emitted electromagnetic radiation, as deflected emitted electromagnetic radiation, through at least one angle into the surrounding area; and receiving, by way of an optical receiver, electromagnetic radiation that has been reflected from the object. The optical receiver has a aperture region, the aperture region being disposed on a main beam axis of the light source.

Four exemplifying embodiments of the present invention will be explained in further detail below with reference to the appended drawings.

### BRIEF DESCRIPTION OF THE DRAWINGS

FIG. 1 is a sketch of a lidar sensor according to the present invention.

FIG. 2 is a sketch of a lidar sensor in accordance with a second embodiment.

FIG. 3 is a sketch of a lidar sensor in accordance with a third embodiment.

FIG. 4 is a sketch of a lidar sensor in accordance with a fourth embodiment.

### DETAILED DESCRIPTION

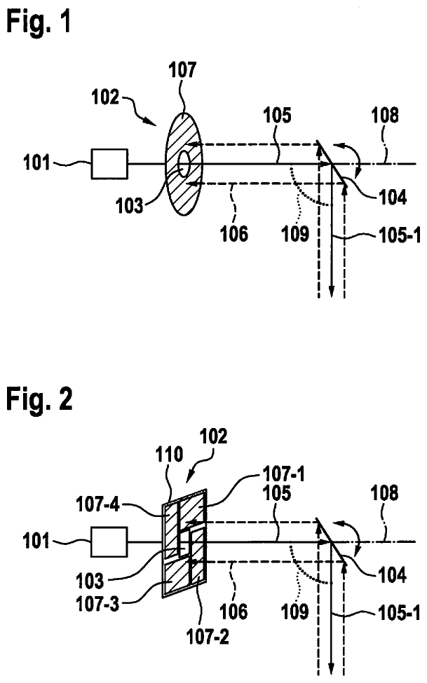

The lidar sensor shown in FIG. 1 has, as a light source 101, a laser that emits electromagnetic radiation 105 in the visible region of the spectrum or optionally also in the infrared region. The lidar sensor furthermore has optical receiver 102. In the example, optical receiver 102 is embodied as an annular detector element 107. Optical receiver 102 has detector element 107, which at least in part surrounds an aperture region 103. A sensitive surface of the detector element can be present entirely, or also in part, around aperture region 103. Detector element 107 has aperture region 103 at its center. Aperture region 103 is embodied as a passage. Light source 101 is disposed on that side of optical receiver 102 which faces away from the surrounding area. Optical receiver 102 is disposed so that passage 103 is disposed on main beam axis 108 of light source 101. Electromagnetic radiation 105 emitted from light source 101 along main beam axis 108 is directed in a very largely loss-free manner through passage 103 onto deflection mirror 104. FIG. 1 shows, by way of example, a free-space beam optical system. Alternatively, emitted electromagnetic radiation 105 can also be directed by way of an optical fiber through passage 103 onto deflection mirror 104.

Deflection mirror 104 is a micromechanical deflection mirror. As indicated by the double arrow, deflection mirror 104 is moved oscillatingly or statically along an axis. It is furthermore possible for deflection mirror 104 to be moved oscillatingly or statically around a second axis that proceeds at right angles to the first axis. Deflection mirror 104 deflects emitted electromagnetic radiation 105, as deflected emitted electromagnetic radiation 105-1, into the surrounding area. Deflection mirror 104 is activated in this context in such a way that in a first orientation, emitted electromagnetic radiation 105 is deflected, as deflected emitted electromagnetic radiation 105-1, through at least one angle into the surrounding area. This one angle 109 is marked in FIG. 1. In a second orientation of the deflection mirror, emitted electromagnetic radiation 105 can be deflected, as deflected emitted electromagnetic radiation 105-1, through at least one further angle, different from the first angle, into the surrounding area.

When deflected emitted electromagnetic radiation 105-1 impinges upon an object in the surrounding area, the electromagnetic radiation is reflected and/or scattered back from the object. The reflected and/or backscattered electromagnetic radiation 106 is received by the lidar sensor. Electromagnetic radiation 106 is incident, via deflection mirror 104, onto optical receiver 102.

FIG. 2 shows, as a modified exemplifying embodiment, a lidar sensor that has the same basic construction as the lidar sensor in FIG. 1. It differs by the fact that optical receiver 102 has detector elements 107-1 to 107-4 that are disposed on at least part of the periphery of optical receiver 102. Detector elements 107-1 to 107-4 are disposed around aperture region 103. It is also possible for optical receiver 102 to have, for example, only three of the detector elements. It is possible, for example, for optical receiver 102 to have only detector elements 107-1 to 107-3. In this case, no detector element would be disposed on part of the periphery of optical receiver 102. It is likewise possible for optical receiver 102 to have only two detector elements or only one detector element. Sensitive surfaces of the detector elements can be present entirely or in part around aperture region 103.

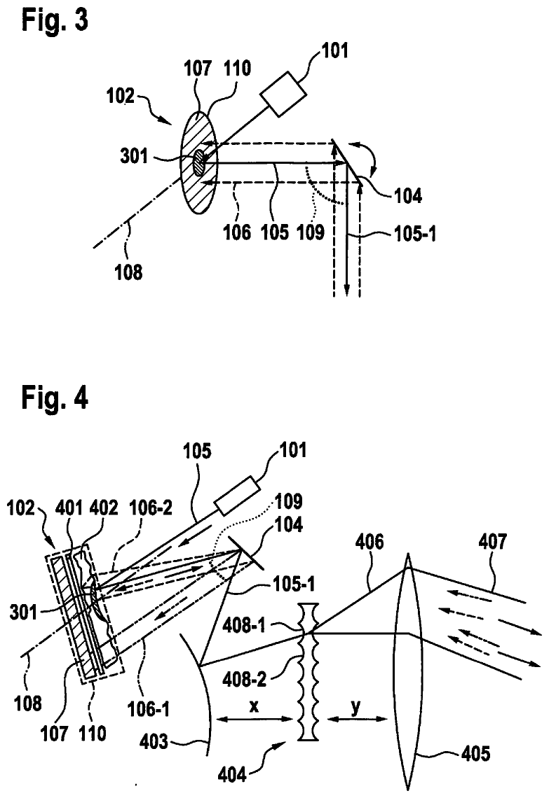

FIG. 3 shows, as a further exemplifying embodiment, a lidar sensor that likewise has a light source 101, an optical receiver 102, and a deflection mirror 104. The features of these components correspond to the features of the same components of the exemplifying embodiments already described. The optical receiver in particular can be embodied in the manner that has already been illustrated for the examples of FIG. 1 and FIG. 2. In the example, optical receiver 102 is embodied as an annular detector element 107. Optical receiver 102 has detector element 107, which at least in part encompasses an aperture region 301.

Detector element 107 has, at its center, aperture region 301. Aperture region 301 is embodied as a mirror. Light source 101 is disposed on that side of optical receiver 102 which faces toward the surrounding area. Optical receiver 102 is disposed so that mirror 301 is disposed on main beam axis 108 of light source 101.

Electromagnetic radiation 105 emitted from light source 101 along main beam axis 108 is diverted in a very largely loss-free manner from mirror 301 onto deflection mirror 104. FIG. 3 shows, by way of example, a free-space beam optical system. Alternatively, emitted electromagnetic radiation 105 can also be directed by way of an optical fiber onto mirror 301 and diverted onto deflection mirror 104.

FIG. 4 shows a lidar sensor in accordance with a further embodiment, which likewise has a light source 101, an optical receiver 102, and a deflection mirror 104. The features of these components correspond to the features of the same components of the exemplifying embodiments already described. The optical receiver in particular can be embodied in the manner that has already been illustrated for the examples of FIG. 1, FIG. 2, and FIG. 3. Optical receiver 102 has detector element 107. Detector element 107 has, at its center, aperture region 301. Aperture region 301 is embodied as a mirror. Optical receiver 102 furthermore has optical filter 401 for limiting or reducing undesired electromagnetic radiation. Optical receiver 102 furthermore has a free-form plastic optical element 402 that serves to collimate received light onto the sensitive surfaces of the detector.

In the lidar sensor shown in FIG. 4, emitted electromagnetic radiation 105, which is directed from light source 101 along main beam axis 108 onto mirror 301 and diverted in a very largely loss-free manner onto deflection mirror 104 of the lidar sensor, is guided by way of deflection mirror 104, as deflected emitted electromagnetic radiation 105-1, onto an array 404 of micro-optical elements 408. In this example, light-diffracting elements 408 are provided as micro-optical elements. Optionally, however, light-refracting or -reflecting elements can also be provided.

The at least one angle through which emitted electromagnetic radiation 105 is deflected as emitted electromagnetic radiation 105-1 is associated with exactly one micro-optical element 408-1, 408-1. Angle 109 depicted in FIG. 4 is associated with micro-optical element 408-1. Several angles of different magnitudes can be associated with each element 408. For example, if emitted electromagnetic radiation 105 is deflected by deflection mirror 104 through an angle whose magnitude differs slightly from the magnitude of angle 109, deflected emitted electromagnetic radiation 105-1 then also impinges upon micro-optical elements 408-1. If the difference in magnitude between angle 109 and a further deflection angle exceeds a predefined value, deflected emitted electromagnetic radiation 105-1 then, for example, impinges upon the adjacent micro-optical element 408-2.

That one of light-diffracting elements 408 which is impinged upon by deflected (emitted) electromagnetic radiation 105-1 expands deflected emitted electromagnetic radiation 105-1 into a divergent beam 406. Divergent beam 406 impinges upon a light-collimating element in the form of a lens 405. The distance y between array 404 and lens 405 corresponds approximately to the focal length of lens 405. Lens 405 shapes divergent beam 406 into an approximately parallel scanning beam 407. The beam diameter of scanning beam 407 is larger than the beam diameter of the beam of emitted electromagnetic radiation 105. The beam diameter of scanning beam 407 is larger than the beam diameter of the beam of deflected emitted electromagnetic radiation 105-1.

The emission direction of scanning beam 407 depends on the location of micro-optical element 408 with reference to the optical axis of light-collimating element 405 that has just been impinged upon by deflected emitted electromagnetic radiation 105-1. As a result, deflection mirror 104 also indirectly brings about a deflection of scanning beam 407. Scanning beam 407 sweeps across the surrounding area of the lidar sensor. The angle range that is swept by scanning beam 407 depends on the focal length of lens 405. It can be considerably greater than twice the angle range within which deflection mirror 104 is moved.

A further mirror unit 403 is provided between deflection mirror 104 and array 404. Mirror unit 403 is disposed at a distance x from array 404. This further mirror unit 403 is embodied as a convex mirror in order to compensate for aberrations. Mirror unit 403 diverts the electromagnetic radiation 105 deflected by deflection mirror 104 in such a way that it is incident onto array 404 along the optical axis of lens 405. Received electromagnetic radiation 106 can also be diverted onto deflection mirror 104 by way of mirror unit 403.

1-15. (canceled).

16. A lidar sensor for detecting an object in the surrounding area, comprising:
a light source for emitting electromagnetic radiation;
a deflection mirror for deflecting the emitted electromagnetic radiation, as deflected emitted electromagnetic radiation, through at least one angle into the surrounding area; and
an optical receiver for receiving electromagnetic radiation that has been reflected from the object;
wherein the optical receiver has an aperture region disposed on a main beam axis of the light source.

17. The lidar sensor of claim 16, wherein the optical receiver has at least one detector element that at least in part surrounds the aperture region.

18. The lidar sensor of claim 16, wherein the optical receiver has at least two detector elements disposed on at least part of the periphery of the optical receiver.

19. The lidar sensor of claim 17, wherein the aperture region includes a passage.

20. The lidar sensor of claim 19, wherein the light source is disposed on a side of the optical receiver which faces away from the surrounding area.

21. The lidar sensor of claim 17, wherein the aperture region includes a mirror.

22. The lidar sensor of claim 21, wherein the light source is disposed on a side of the optical receiver which faces toward the surrounding area.

23. The lidar sensor of claim 16, wherein the deflection mirror includes a micromechanical deflection mirror.

24. The lidar sensor of claim 16, further comprising:
an array of micro-optical elements;
wherein the deflection mirror and the array are disposed so that the at least one angle is associated with exactly one micro-optical element.

25. The lidar sensor of claim 24, further comprising:
a light-collimating element disposed at a distance from the array of micro-optical elements;
wherein each of the micro-optical elements, when impinged upon by the deflected emitted electromagnetic radiation, expand the deflected emitted electromagnetic radiation into a divergent beam, and
wherein the light-collimating element reshape the divergent beam into a scanning beam.

26. The lidar sensor of claim 24, wherein the micro-optical elements include microlenses, reflective elements or light-diffracting elements.

27. The lidar sensor of claim 24, wherein the light-collimating element simultaneously constitute an objective of the optical receiver.

28. The lidar sensor of claim 24, wherein a mirror unit, which diverts the deflected emitted electromagnetic radiation onto the array of micro-optical elements, is disposed on the optical axis of the light-collimating element.

29. The lidar sensor of claim 28, wherein the mirror unit is configured convexly.

30. A method for activating a lidar sensor for detecting an object in the surrounding area, the method comprising:
activating a light source to emit electromagnetic radiation;
activating a deflection mirror to deflect the emitted electromagnetic radiation, as deflected emitted electromagnetic radiation, through at least one angle into the surrounding area; and
receiving, by an optical receiver, electromagnetic radiation that has been reflected from the object;
wherein the optical receiver has an aperture region, which is disposed on a main beam axis of the light source.
